(19) United States
(12) Patent Application Publication
(10) Pub. No.: US 2003/0078850 A1
(43) Pub. Date: Apr. 24, 2003

(54) Electronic marketplace system and method using a support vector machine

(76) Inventors: Eric Hartman, Austin, TX (US); Bruce Ferguson, Round Rock, TX (US); Doug Johnson, Austin, TX (US); Eric Hurley, Austin, TX (US); Lori Petrone, Austin, TX (US)

Correspondence Address: Jeffrey C. Hood, Conley, Rose, & Tayon, P.C., P.O.Box 398, Austin, TX, 78767, US

(21) Appl. No.: 09/946,830

(22) Filed: Sep. 5, 2001

(51) Int. Cl. G06F 17/60

(52) U.S. Cl. 705/26

(57) ABSTRACT

A system and method for optimizing transactions in an e-marketplace. An e-marketplace optimization server couples to a plurality of participant computers through a network. The server hosts a site which provides the e-marketplace where goods and/or services are bought and sold among participants. The server also includes a transaction optimization program which mediates a transaction among the participants which best serves the needs of the participants. Each of the participant computers provides transaction information to the server, including constraints and/or objectives related to the transaction. The transaction optimization program uses the transaction information to produce transaction results for the participants, including an optimized transaction specifying which of the participants are included in the transaction, and the terms of the transaction, which optimizes any objectives of the included participants subject to any constraints of the included participants. The transaction optimization program includes a support vector machine model of the e-marketplace.

### BACKGROUND OF THE INVENTION

1. Field of the Invention

The present invention relates generally to the fields of e-commerce and optimization. More particularly, the present invention relates to optimization applied to e-marketplace operations.

2. Description of the Related Art

Electronic commerce has become an increasingly popular form of commerce in the United States and throughout the world. In a business-to-consumer context, electronic commerce, often referred to as e-commerce or Internet-based commerce, provides vendors and service providers the ability to greatly increase their sales channel and distribution network with minimal cost. An electronic commerce site provides a convenient and effective mechanism for potential participants to use, select and purchase goods or services in an easy and simple fashion over a computer network.

An important part of e-commerce involves business-to-business (B2B) transactions, such as trade between manufacturers and suppliers, or between retailers and wholesalers. One example of a B2B e-commerce center is an e-marketplace, where various companies in an industry compete and/or cooperate to place or fill orders for goods and/or services. One mechanism for these transactions is to have suppliers compete for manufacturers' orders in live, open, electronic auctions. This is referred to as a buyer's auction. Another mechanism, called a seller's auction, involves buyers competing for orders from sellers (suppliers).

The use of auctions to sell commodities is not a new concept. Basic commodities like wheat and fuel oil are bought and sold through auctions called futures exchanges, and have been for many years. Auction sites on the Internet are used to buy and sell standard processed materials like steel, chemicals, and plastics. The global spot market auctions provide significant savings over standard purchasing methods.

However, manufacturers typically spend far less on raw materials than they do on manufactured components, such as the individually crafted parts—the motors, gears, circuit boards, and plastic casings that producers forge into finished products such as automobiles and washing machines. These components are generally purchased on contracts that typically run three or four years, and they are not standardized. It is estimated that more than a third of manufacturing expenses goes toward purchasing industrial parts. Because of these issues, B2B auctions are increasingly used to buy and sell manufactured components.

Companies that currently offer some form of e-marketplace include FreeMarkets.com and e-steel, among others.

Generally, these B2B e-marketplaces provide a forum for participants to bid on orders. However, there is currently no known method to take into account the various objectives and/or constraints of each participant in developing a successful transaction, i.e., there is no current method or system which can optimize the transaction to serve the needs of both buyers and sellers.

Therefore, improved systems and methods for conducting e-commerce over a network are desired.

### SUMMARY OF THE INVENTION

The present invention comprises various embodiments of a system and method for optimizing transactions in an e-marketplace. In one embodiment, an e-marketplace optimization server is coupled to a plurality of participant computers through a network. Each of the participant computers may be operated by or on behalf of a participant. As used herein, the term “participant” is used to refer to one or both of a participant and a participant computer. The network may be a Local Area Network (LAN), or a Wide Area Network (WAN) such as the Internet.

In one embodiment, the e-marketplace optimization server may host a site which is operable to provide the e-marketplace. In the e-marketplace, goods and services may be bought and sold among participants. Each participant may be a buyer or a seller, or optionally a service provider, depending upon a particular transaction being conducted. The e-marketplace site may thus provide various types of transaction services, such as purchasing or selling goods or services, as well as providing various services (or allocating service providers) for items such as insurance, transportation, financing, and other aspects of a transaction. The e-marketplace may serve to facilitate the buying and selling of goods and services in any industry, including metals, wood and paper, food, manufacturing, electronics, healthcare, insurance, finance, or any other industry in which goods or services may be bought and sold.

The e-marketplace optimization server, in addition to hosting the e-marketplace site, may also be operable to provide optimization services to e-marketplace transactions. The optimization services may comprise mediating a transaction among the participants such that the desired outcome best serves the needs and/or desires of two or more of the participants. In one embodiment, the transaction may be optimized by a transaction optimization program or engine which is stored and executed on the e-marketplace optimization server. The transaction optimization program may include a model of the e-marketplace. The model of the e-marketplace may be a support vector machine. The term “support vector machine” is used synonymously with “support vector” herein.

The support vector method is a recently developed technique which is designed for efficient multidimensional function approximation. The basic idea of support vector machines (SVMs) is to determine a classifier or regression machine which minimizes the empirical risk (i.e., the training set error) and the confidence interval (which corresponds to the generalization or test set error), that is, to fix the empirical risk associated with an architecture and then to use a method to minimize the generalization error. One advantage of SVMs as adaptive models for binary classification and regression is that they provide a classifier with minimal VC (Vapnik-Chervonenkis) dimension which implies low expected probability of generalization errors. SVMs may be used to classify linearly separable data and nonlinearly separable data. SVMs may also be used as nonlinear classifiers and regression machines by mapping the input space to a high dimensional feature space. In this high dimensional feature space, linear classification may be performed.

The plurality of participant computer systems may be coupled to the server computer system over the network. Each of the participant computers may be operable to provide transaction information, also referred to as transaction requirements, to the server. For each of the plurality of participants, the transaction information may include one or more of constraints and/or objectives related to the transaction. The constraints and/or objectives may include parameter bounds, functions, algorithms, and/or models which specify each participant's transaction guidelines. In one embodiment, each participant may, at various times, modify the corresponding transaction information to reflect the participant's current transaction objectives and/or constraints. Each participant's transaction information may be sent to the e-marketplace optimization server. The e-marketplace optimization server may then execute the transaction optimization program using the transaction information from each of the plurality of participant computer systems to produce transaction results for each of the plurality of participants. After the transaction optimization program executing on the e-marketplace server has generated the transaction results, the transaction results may be sent to each of the participants over the network. In one embodiment, the transaction results may include an optimized transaction specifying which of the participants is included in the transaction, as well as the terms of the transaction.

The transaction optimization program may be executed using the transaction information from each of the participants to produce transaction results for each of the participants. The transaction results may include a set of transaction terms which specify a transaction between two or more of the participants which optimizes the objectives of the two or more participants subject to the constraints of the two or more participants.

As mentioned above, the objectives may codify the goals of a participant with regard to the transaction, such as increasing revenues or market share, decreasing inventory, minimizing cost, or any other desired outcome of the transaction. The constraints for a given participant may specify limitations which may bound the terms of an acceptable transaction for that participant, such as maximum or minimum order size, time to delivery, profit margin, total cost, or any other factor which may serve to limit transaction terms.

As noted above, constraints may be expressed not only as value bounds for parameters, but also in the form of functions or models. For example, a participant may provide a model to the e-marketplace and specify that an output of the model is to be minimized, maximized, or limited to a particular range. Thus the behavior of the model may constitute a constraint or limitation on a solution. Similarly, a model may be used to express objectives of a transaction for a participant.

In one embodiment, after the results have been provided to the participants, the participants may adjust their constraints and/or objectives and re-submit them to the transaction optimization server, initiating another round of transaction optimization. This may continue in an iterative fashion until a pre-determined number of rounds have elapsed, or until the participants agree to terminate the process.

In one embodiment, the server computer system may also store an interface program which is executable to present a graphical user interface to the participant. The graphical user interface may comprise any interface mechanism whereby transaction information or results may be communicated between the participant and the transaction optimization program, such as Pavilion's e-Perfecter. Such information may include text, graphics, or audio. The interface provided by the interface program may be operable to allow communication between the participant and the transaction optimization program, such that the participant may send transaction information to the transaction optimization program, and the transaction optimization program may send results to the participant.

It should be noted that using a graphical user interface to specify transaction information is but one possible embodiment which focuses on a human participant being in the loop. In this approach the human configures the information, submits them to the market, receives, authorizes, and acts on the transaction result returned by the market. In another embodiment, the information may be configured and submitted automatically by the participant computer, i.e., a program may determine and submit the transaction information. In turn the result from the marketplace may be acted on automatically through a deal-fulfillment mechanism of the marketplace and/or the participants business software. In other words, in both approaches, optimization may be used to compute the optimal transaction, and the technique can be used in both automated and manual transaction-execution systems. Thus, the invention does not require a manual transaction execution. However, for purposes of illustration, the man-machine interface approach has been used in the following descriptions of the invention.

Typically, for a given transaction, the participants may include a plurality of buyers or sellers who compete with one another to place or fill an order for a product or service. Other participants may include insurance providers, transportation providers, financing entities, and other types of service providers to a transaction. The participants may each send their objectives and/or constraints (transaction information) to the transaction optimization program, which may execute an optimization program to generate an optimized transaction (transaction results) specifying terms of a transaction between two or more of the participants. The optimized transaction terms may include product type, order size, order schedule, transaction participants, financing terms, delivery terms, insurance terms, or any other information describing the optimized transaction.

In one embodiment, at least one participant may be a buyer and a plurality of participants may be sellers, wherein the transaction comprises a purchase by the buyer of a product from one of the plurality of sellers. In this case, the transaction results generated by the transaction optimization program may comprise selection of at least one seller from the plurality of sellers to sell the product to the buyer. This may be referred to as a buyer's market.

In another embodiment, at least one participant may be a seller and a plurality of participants may be buyers, wherein the transaction comprises a purchase by one or more of the plurality of buyers of a product from the seller. The transaction results generated by the transaction optimization program may comprise selection of at least one buyer from the plurality of buyers to buy the product from the seller. This may be referred to as a seller's market.

In yet another embodiment, a plurality of buyer participants and a plurality of seller participants may all engage in a complex transaction, such that the optimized transaction may involve a multitude of sub-transactions conducted among various buyers and sellers.

As noted above, when a buyer places an order for a product, there may be many factors related to the order besides the product specification. Such additional factors may include financial arrangements such as payment schedule and credit terms, or delivery arrangements, such as delivery schedule, selection of delivery services, and cost. These services may typically be bought and sold in their own respective e-marketplaces, such as a finance e-marketplace and a logistics e-marketplace, mentioned above. In one embodiment, these ancillary e-marketplaces may be coupled to the goods e-marketplace to provide an intermarket of goods and services, i.e., combining the goods and services of numerous industries into a single “one-stop” marketplace for a participant by adding these ancillary terms to a transaction.

### BRIEF DESCRIPTION OF THE DRAWINGS

Other objects and advantages of the invention will become apparent upon reading the following detailed description and upon reference to the accompanying drawings in which:

FIG. 1 illustrates a network system suitable for implementing an e-marketplace, according to one embodiment;

FIGS. 2a and 2b illustrate an e-marketplace with transaction optimization, according to one embodiment, wherein FIG. 2a illustrates various participants providing transaction requirements to the e-marketplace optimization server, and FIG. 2b illustrates various participants receiving transaction results from the e-marketplace optimization server;

FIG. 3 is a flowchart of a transaction optimization process, according to one embodiment;

FIG. 4 illustrates an e-marketplace with a participant, according to one embodiment;

FIG. 5 illustrates an e-marketplace with multiple participants, according to one embodiment;

FIG. 6 illustrates a goods e-marketplace, according to one embodiment;

FIG. 7 illustrates a goods e-marketplace networked with a plurality of other e-marketplaces, according to one embodiment;

FIGS. 8a and 8b illustrate a system for optimizing an e-marketplace, according to one embodiment; and

FIG. 9 illustrates a support vector machine implementation, according to one embodiment.

While the invention is susceptible to various modifications and alternative forms, specific embodiments thereof may be shown by way of example in the drawings and will herein be described in detail. It should be understood, however, that the drawing and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF SEVERAL EMBODIMENTS

Incorporation by Reference

U.S. Pat. No. 5,950,146, titled “Support Vector Method For Function Estimation”, whose inventor is Vladimir Vapnik, and which issued on Sep. 7, 1999, is hereby incorporated by reference in its entirety as though fully and completely set forth herein.

U.S. Pat. No. 5,649,068, titled “Pattern Recognition System Using Support Vectors”, whose inventors are Bernard Boser, Isabelle Guyon, and Vladimir Vapnik, and which issued on Jul. 15, 1997, is hereby incorporated by reference in its entirety as though fully and completely set forth herein.

U.S. patent application Ser. No. 09/493,951, titled “System And Method For Optimization Including Cross-Record Constraints”, whose inventors are Frank D. Caruana, Pinchas Ben-Or, Abhijit Chatterjee, Timothy L. Smith, Thomas J. Traughber, Rhonda Alexander, Michael E. Niemann, Matthew M. Harris and Steven J. Waldschmidt, and filed on Jan. 28, 2000, is hereby incorporated by reference in its entirety as though fully and completely set forth herein.

U.S. patent application Ser. No. 09/493,404, titled “System And Method For Generating Inducements During E-Commerce Transactions Using An Optimization Process”, whose inventors are Edmond Herschap III, Timothy J. Magnuson, Thomas J. Traughber, and Kasey White, and filed on Jan. 28, 2000, is hereby incorporated by reference in its entirety as though fully and completely set forth herein.

U.S. patent application Ser. No. ______, titled “System And Method For On-Line Training Of A Support Vector Machine”, whose inventors are Eric Hartman, Bruce Ferguson, Doug Johnson, and Eric Hurley, and filed concurrently herewith, is hereby incorporated by reference in its entirety as though fully and completely set forth herein.

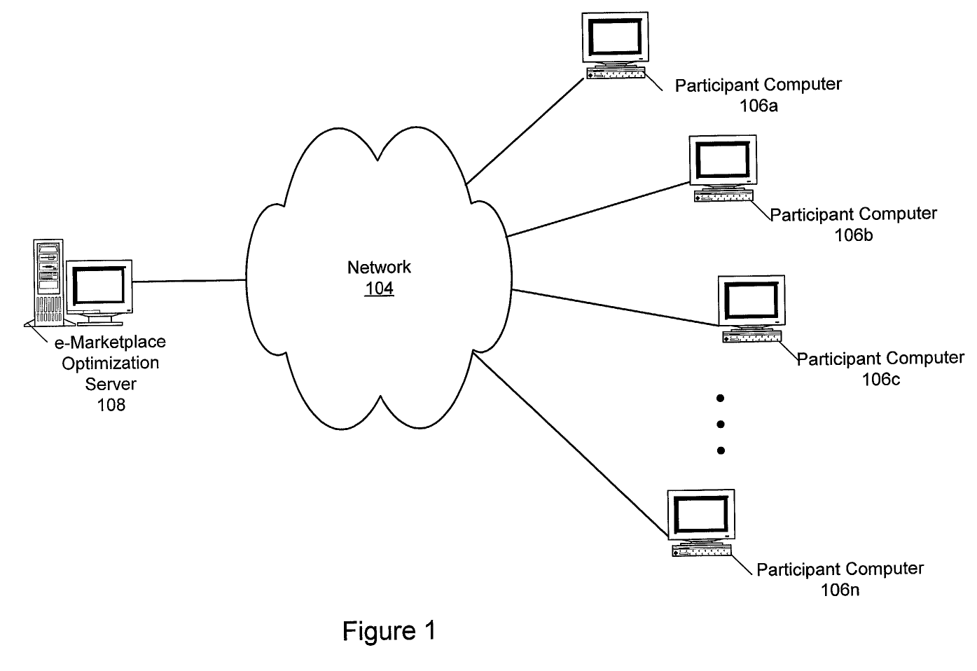

FIG. 1: An E-Marketplace System

FIG. 1 illustrates a network system suitable for implementing an e-marketplace, according to one embodiment. As FIG. 1 shows, an e-marketplace optimization server 108 is communicatively coupled to a plurality of participant computers 106 through a network 104. Each of the participant computers 106 may be operated by or on behalf of a participant. As used herein, the term “participant” is used to refer to one or both of participant and participant computer 106. The network 104 may be a Local Area Network (LAN), or a Wide Area Network (WAN) such as the Internet.

In one embodiment, the e-marketplace optimization server 108 may host an e-commerce site which is operable to provide an e-marketplace where goods and services may be bought and sold among participants 106. The e-marketplace optimization server 108 may comprise one or more server computer systems for implementing e-marketplace optimization as described herein.

Each participant 106 may be a buyer or a seller, or possibly a service provider, depending upon a particular transaction being conducted. Note that for purposes of simplicity, similar components, e.g., participant computers 106a, 106b, 106c, and 106n may be referred to collectively herein by a single reference numeral, e.g., 106.

The e-marketplace optimization server 108 preferably includes a memory medium on which computer programs according to various embodiments of the present invention may be stored. For example, the e-marketplace optimization server 108 may store a transaction optimization program according to one embodiment of the invention for optimizing e-marketplace transactions among a plurality of participants 106. The e-marketplace optimization server 108 may also store web site hosting software according to one embodiment of the invention for presenting various graphical user interfaces (GUls) on the various participant computer systems 106 and for communicating with the various participant computer systems 106. The GUIs presented on the various participant computer systems 106 may be used to allow the participants to provide transaction requirements to the e-marketplace optimization server 108 or receive transaction results from the e-marketplace optimization server 108.

Thus, an e-marketplace may function as a forum to facilitate transactions between participants and may comprise an e-commerce site. The e-commerce site may be hosted on an e-commerce server computer system.

The term “memory medium” is intended to include various types of memory or storage, including a computer system memory or random access memory such as DRAM, SRAM, EDO RAM, Rambus RAM, etc., a non-volatile memory such as a magnetic media, e.g., a hard drive, or optical storage, or an installation medium, e.g., a CD-ROM, or floppy disks. The memory medium may comprise other types of memory as well, or combinations thereof. In addition, the memory medium may be located in a first computer in which the programs are executed, or may be located in a second different computer which connects to the first computer over a network. In the latter instance, the second computer provides the program instructions to the first computer for execution. Also, the e-marketplace optimization server 108 may take various forms, including one or more connected computer systems. In general, the term “computer system” may be broadly defined to encompass any device having a processor which executes instructions from a memory medium.

The memory medium preferably stores one or more software programs for providing an e-marketplace and optimizing transactions among various participants. The software program may be implemented in any of various ways, including procedure-based techniques, component-based techniques, and/or object-oriented techniques, among others. For example, the software program may be implemented using ActiveX controls, C++ objects, Java objects, Microsoft Foundation Classes (MFC), or other technologies or methodologies, as desired. A CPU, such as the host CPU, executing code and data from the memory medium comprises a means for creating and executing the software program according to the methods or flowcharts described below.

Various embodiments further include receiving or storing instructions and/or data implemented in accordance with the foregoing description upon a carrier medium. Suitable carrier media include a memory medium as described above, as well as signals such as electrical, electromagnetic, or digital signals, conveyed via a communication medium such as networks and/or a wireless link.

In one embodiment, each of the participant computers 106 may include a memory medium which stores standard browser software, which is used for displaying a graphical user interface presented by the e-marketplace optimization server 108. In another embodiment, each of the participant computers 106 may store other client software for interacting with the e-marketplace optimization server 108.

The e-marketplace may serve to facilitate the buying and selling of goods and services in any industry, including metals, wood and paper, food, manufacturing, electronics, healthcare, insurance, finance, or any other industry in which goods or services may be bought and sold. In one embodiment, the e-marketplace may serve the chemical manufacturing industry, providing a forum for the purchase and sale of raw chemicals and chemical products. There may be multiple suppliers (sellers) of a given product, such as polypropylene for example, and a single buyer who wishes to place an order for the product. The multiple suppliers may compete to fill the order of the single buyer. In another embodiment, there may be multiple buyers and one supplier of a product. The multiple customers may then compete to receive an order from the supplier. In yet another embodiment, there may be multiple buyers and multiple sellers involved in a given transaction, in which case a complex transaction may result in which multiple sub-transactions may be conducted among the participants 106.

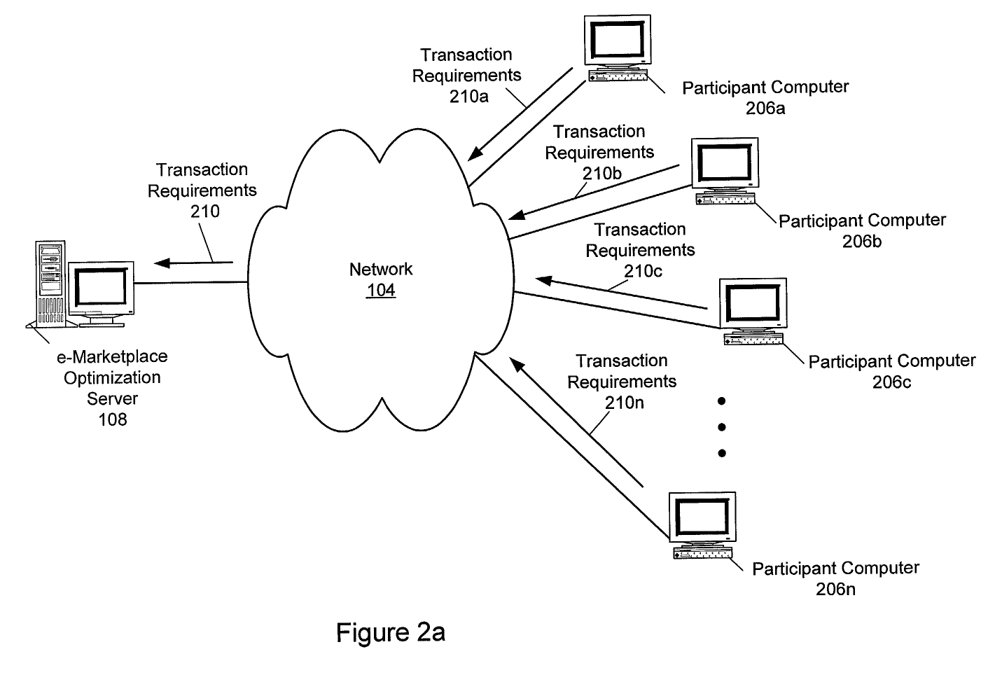

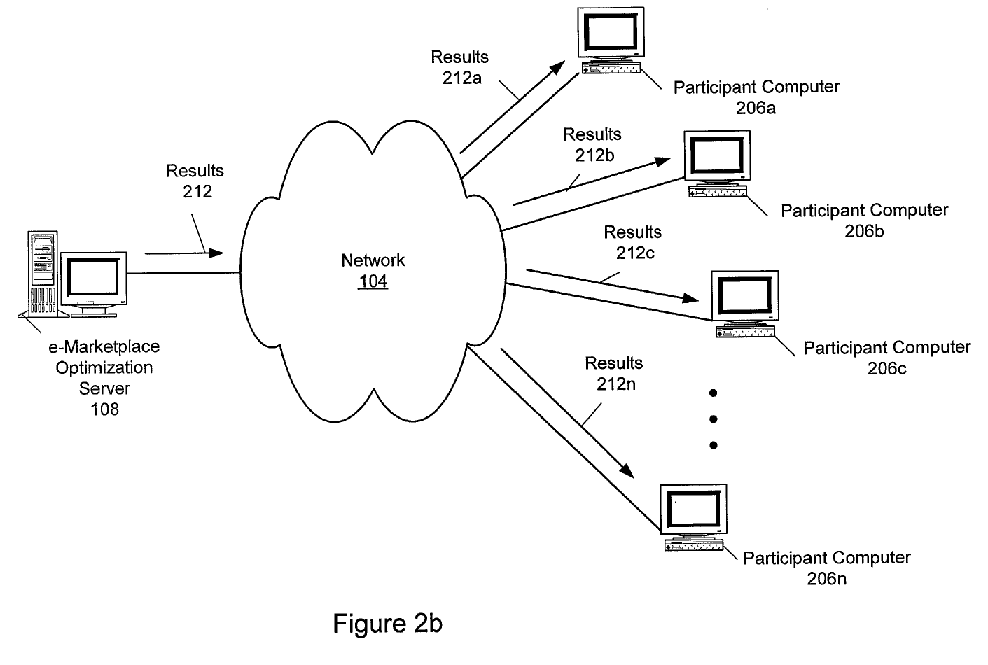

FIGS. 2a and 2b: An E-Marketplace with Transaction Optimization

FIGS. 2a and 2b illustrate an e-marketplace system with transaction optimization, according to one embodiment. As shown, the embodiments illustrated in FIGS. 2a and 2b are substantially similar to that illustrated in FIG. 1. FIG. 2a illustrates various participants 106 providing transaction requirements 210 to the e-marketplace optimization server 108, and FIG. 2b illustrates various participants 106 receiving transaction results from the e-marketplace optimization server 108.

The e-marketplace optimization server 108, in addition to hosting the e-marketplace site, may also be operable to provide optimization services to the e-marketplace. The optimization services may comprise mediating a transaction among the participants 106 such that the desired outcome best serves the needs and/or desires of two or more of the participants. In one embodiment, the transaction may be optimized by a transaction optimization program or engine which is stored and executed on the e-marketplace optimization server 108. For example, in the case mentioned above where there are multiple sellers and one buyer, the transaction optimization program may generate a transaction which specifies one of the sellers to provide the product order to the buyer, at a particular price, by a particular time, such that the buyer's needs are met as well as those of the seller.

As shown in FIG. 2a, the plurality of participant computer systems 106 may be coupled to the server computer system 108 over the network 104. Each of the participant computers 106 may be operable to provide transaction requirements 210 to the server 108. For each of the plurality of participants, the transaction requirements 210 may include one or more of constraints, objectives and other information related to the transaction. The constraints and/or objectives may include parameter bounds, functions, algorithms, and/or models which specify each participant's transaction guidelines. In one embodiment, each participant may, at various times, modify the corresponding transaction requirements 210 to reflect the participant's current transaction constraints and/or objectives. As noted above, constraints may be expressed not only as value bounds for parameters, but also in the form of functions or models. For example, a participant may provide a model to the e-marketplace and specify that an output of the model is to be minimized, maximized, or limited to a particular range. Thus the behavior of the model may constitute a constraint or limitation on a solution. Similarly, a model (or function) may also be used to express objectives of the transaction for a participant.

As FIG. 2a shows, each participant's transaction requirements 210 may be sent to the e-marketplace optimization server 108. The e-marketplace optimization server 108 may then execute the transaction optimization program using the transaction requirements 210 from each of the plurality of participant computer systems to produce optimized transaction results for each of the plurality of participants. The transaction optimization program may include a model of at least a portion of the e-marketplace. For example, the model may comprise a model of a transaction, of one or more participants, or the e-marketplace itself. In one embodiment, the model may be implemented as a support vector machine. The term “support vector machine” is used synonymously with “support vector” herein.

In one embodiment, the transaction optimization program may use the model to predict transaction results for each of the plurality of participants. The transaction optimization program may use these results to optimize the transaction among a plurality of participants.

As shown in FIG. 2b, after the transaction optimization program executing on the e-marketplace server 108 has generated the transaction results, the transaction results may be sent to each of the participants 106 over the network 104. In one embodiment, the transaction results may specify which of the participants is included in the transaction, as well as the terms of the transaction and possibly other information.

In one embodiment, each of the participants may receive the same transaction results 212, i.e. each of the participants may receive the terms of the optimized transaction, including which of the participants were selected for the transaction. In another embodiment, each participant may receive only the transaction results 212 which apply to that participant. For example, the terms of the optimized transaction may only be delivered to those participants which were included in the optimized transaction, while the participants which were excluded from the transaction (or not selected for the transaction) may receive no results. In another embodiment, the terms of the optimized transaction may be delivered to each of the participants, but the identities of the participants selected for the optimized transaction may be concealed.

In one embodiment, the transaction optimization program may include an optimizer which operates to optimize the transaction according to the constraints and/or objectives comprised in the transaction requirements 210 from each of the plurality of participant computer systems 106.

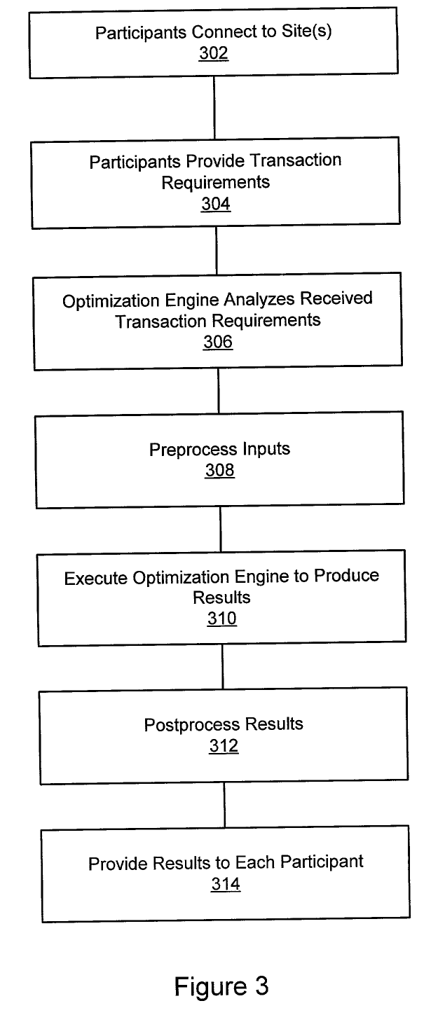

FIG. 3: Transaction Optimization Process

FIG. 3 is a flowchart of a transaction optimization process, according to one embodiment. As FIG. 3 shows, in step 302, transaction participants connect to an e-marketplace site over a network 104, such as the Internet. The e-marketplace site may be hosted on e-marketplace server 108. The participants preferably connect to the e-marketplace server using participant computer systems 106 which are operable to communicate with the e-marketplace server 108 over the network 104. In one embodiment, the participants may communicate with the e-marketplace server through a web browser, such as Netscape Navigator™ or Microsoft Internet Explorer™. In another embodiment, custom client/server software may be used to communicate between the server and the participants.

In step 304, the participants each provide transaction requirements 210 to the e-marketplace server. The transaction requirements 210 may include one or more constraints and/or objectives for a given participant. The objectives may codify the goals of a participant with regard to the transaction, such as increasing revenues or market share, decreasing inventory, minimizing cost, or any other desired outcome of the transaction. The constraints for a given participant may specify limitations which may bound the terms of an acceptable transaction for that participant, such as maximum or minimum order size, time to delivery, profit margin, total cost, or any other factor which may serve to limit transaction terms.

In step 306, a transaction optimization engine may optionally analyze the transaction requirements 210 (constraints and/or objectives). In one embodiment, the transaction requirements 210 may be analyzed to filter out unfeasible parameters, e.g. bad data, for example, such as uninitialized or missing parameters.

In step 308, the transaction optimization engine may optionally preprocess a plurality of inputs from the plurality of e-marketplace participants providing one or more transaction terms which describe the specifics of the desired transaction, such as order quantity or quality, or product type. The inputs may be preprocessed to aid in formulating the optimization problem to be solved.

In step 310, the transaction optimization program may be executed using the transaction requirements 210 from each of the participants to produce transaction results for each of the participants. The transaction results may include a set of transaction terms which specify a transaction between two or more of the participants which optimizes the objectives of the two or more participants subject to the constraints of the two or more participants.

In step 312, the transaction optimization engine may optionally post process the optimized transaction results 212. Such post processing may be performed to check for reasonable results, or to extract useful information for analysis.

Finally, in step 314, the transaction results 212 are provided to the participants. At this point, the resultant optimized transaction may be executed among the two or more participants specified in the optimized transaction.

In one embodiment, after the results 212 have been provided to the participants, the participants may adjust their constraints and/or objectives and re-submit them to the transaction optimization server, initiating another round of transaction optimization. This may continue until a predetermined number of rounds has elapsed, or until the participants agree to terminate the process.

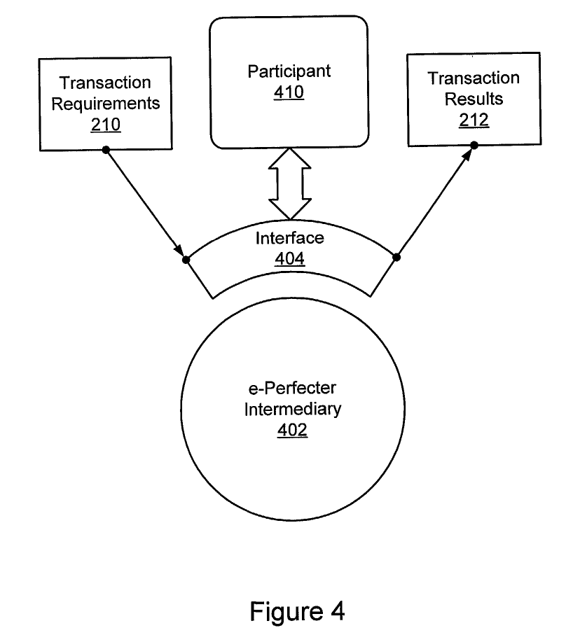

FIG. 4: E-Marketplace with Participant

FIG. 4 illustrates an e-marketplace site with a transaction optimization engine 402, such as Pavilion's e-Perfecter™, which may serve as an intermediary between various participants in a business transaction, according to one embodiment. The e-marketplace site and transaction optimization engine may be hosted on the server computer system 108, referenced in FIGS. 1 and 2, which is communicatively coupled to a participant 410 through a network. As mentioned above, the term “participant” may refer to a user, the user's computer, or both.

In one embodiment, the server computer system may also store a interface program which is executable to present a graphical user interface 404 to the participant 410. The graphical user interface 404 may comprise any interface mechanism whereby transaction requirements 210 or results 212 may be communicated between the participant 410 and e-Perfecter 402, such as text, graphics, or audio. The interface 404 provided by the interface program may be operable to allow communication between the participant 410 and e-Perfecter 402, such that the participant 410 may send transaction requirements 210 to e-Perfecter 402, and e-Perfecter 402 may send results 212 to the participant 410. As shown described above, the transaction requirements 210 may comprise the participant's constraints and/or objectives regarding the business transaction. In one embodiment, the transaction requirements 210 for the participant 410 may be stored on the participant computer 410. In another embodiment, the participant's transaction requirements 210 may be stored on the transaction optimization (or e-commerce) server 108 which hosts e-Perfecter 402. The participant computer 410 may be further operable to receive and display the transaction results 212 sent by the transaction optimization server 108.

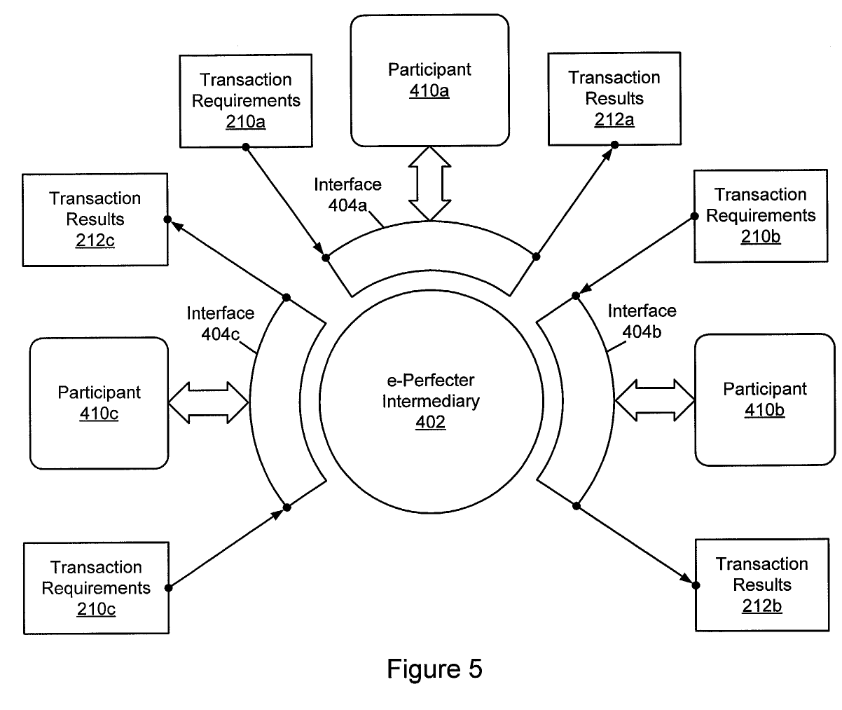

FIG. 5: E-Marketplace with Multiple Participants

FIG. 5 illustrates the e-marketplace site 402 of FIG. 4, but with a plurality of participants 410 coupled to the site. Note that although three participants 410 are shown connected to the e-marketplace site 402, this is for illustration purposes only. The number of participants 410 which may be coupled to the site 402 may be limited only by the resources available to the transaction optimization server 108 hosting the site and the site software configuration. In one embodiment, the transaction optimization server computer system 108 is operable to be coupled to a network and each of the plurality of participant computer systems 410 is also operable to be coupled to the network. In this manner, each of the participants 410 may communicate with the transaction optimization server 108.

As mentioned above, each participant 410 may connect to the server computer 108 which hosts a transaction optimization program, such as e-Perfecter 402. Each participant 410 may communicate with e-Perfecter 402 through an interface 404. As described above, each participant 410 may provide transaction requirements 210 to e-Perfecter 402 in the form of a set of constraints and/or objectives regarding a business transaction. The e-Perfecter system 402 may be operable to mediate an optimized transaction between two or more of the participants 410 such that the transaction is optimized to meet the transaction requirements 210, i.e., constraints and/or objectives, of the two or more participants, and send the terms of the optimized transaction to each of the participants 410 in the form of transaction results 212.

Typically, for a given transaction, the participants 410 may include a plurality of buyers or sellers who compete with one another to place or fill an order for a product or service. The participants 410 may each send their constraints and/or objectives (transaction requirements 210) to e-Perfecter, which may execute an optimization program to generate an optimized transaction (transaction result 212) specifying terms of a transaction between two or more of the participants 410. The optimized transaction terms may include product type, order size, order schedule, transaction participants, or any other information describing the optimized transaction.

In one embodiment, at least one participant may be a buyer and a plurality of participants may be sellers, wherein the transaction comprises a purchase by the at least one buyer of a product from one of the plurality of sellers. In this case, the transaction results generated by e-Perfecter may comprise selection of at least one seller from the plurality of sellers to sell the product to the at least one buyer. This may be referred to as a buyer's market.

In another embodiment, at least one participant may be a seller and a plurality of participants may be buyers, wherein the transaction comprises a purchase by one or more of the plurality of buyers of a product from the at least one seller. The transaction results generated by e-Perfecter may comprise selection of at least one buyer from the plurality of buyers to buy the product from the at least one seller. This may be referred to as a seller's market.

In yet another embodiment, a plurality of buyer participants and a plurality of seller participants may all engage in a complex transaction, such that the optimized transaction may involve a multitude of sub-transactions conducted among various buyers and sellers.

In some cases, the transaction optimization program 402 may be unable to produce transaction results 212 based on the received or current transaction requirements 210. In one embodiment, the transaction optimization program 402 may be operable to detect this condition and be executable to request new transaction requirements 210 from each of the plurality of participant computer systems 410. Upon reception of the new transaction requirements 210, the transaction optimization program 402 may process the new transaction requirements 210 and attempt to generate new transaction results 212 based on the new transaction requirements 210, wherein the new transaction results 212 comprise a new optimized transaction based upon the new constraints and/or objectives comprised in the new transaction requirements 210.

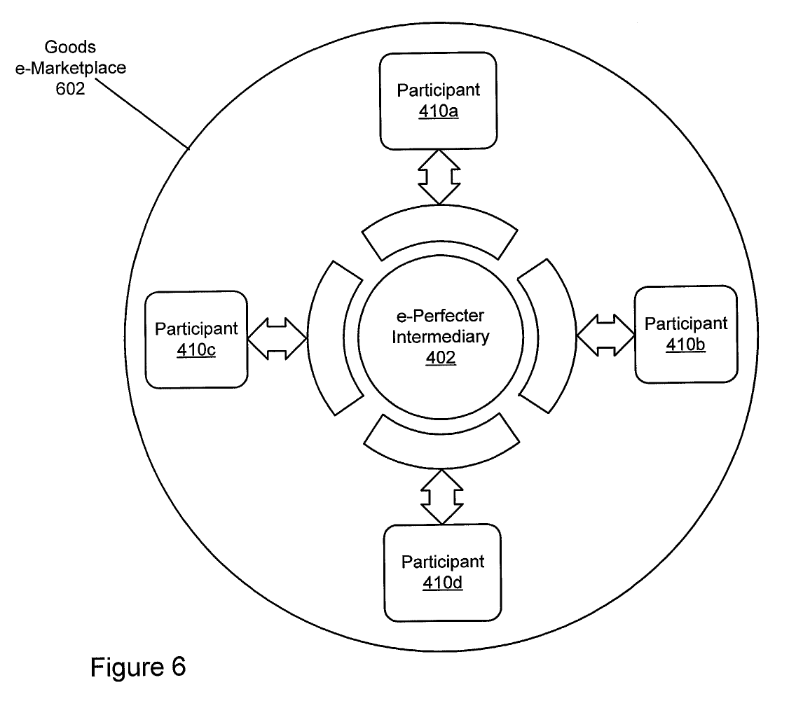

FIG. 6: A Goods E-Marketplace

FIG. 6 is an illustration of an e-marketplace suitable for buying and selling goods over a network among a plurality of participants, according to one embodiment. As FIG. 6 shows, a plurality of participants 410 may be communicatively coupled to a transaction optimization program, such as e-Perfecter 402, which may be hosted on e-marketplace optimization server 108, referenced in FIGS. 1 and 2.

The e-marketplace 602 may comprise a forum to facilitate optimized transactions between the participants 410 in a variety of industries such as chemical products and services, paper products and services, insurance, financial products and services, agricultural products, electronics, automotive products, or any other industry where goods or services may be bought and sold.

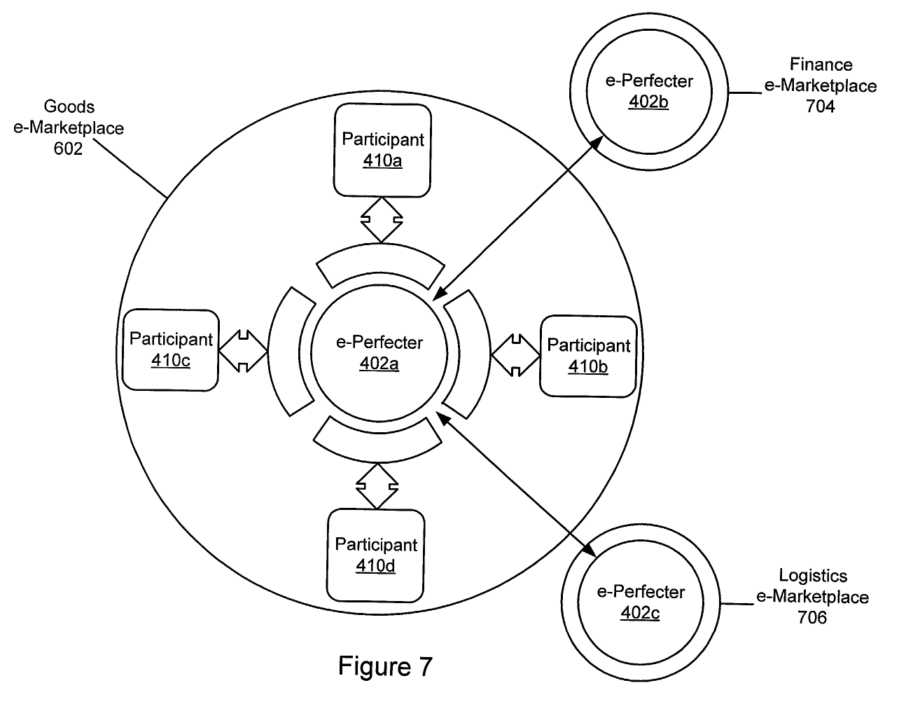

FIG. 7: A Network of E-Marketplaces

FIG. 7 illustrates the goods e-marketplace of FIG. 6 networked to various other e-marketplaces, according to one embodiment. As FIG. 7 shows, goods e-marketplace 602, described in detail above with reference to FIGS. 1-2, may be coupled to a finance e-marketplace 704 and a logistics e-marketplace 706. As shown, the finance e-marketplace 704 and the logistics e-marketplace 706 may each use the e-Perfecter transaction optimization program 402 to provide transaction optimization among the participants of each e-marketplace.

When a customer places an order for a product, there may be many factors related to the order besides the product specification. Such additional factors may include financial arrangements such as payment schedule and credit terms, or delivery arrangements, such as delivery schedule, selection of delivery services, and cost. These services may typically be bought and sold in their own respective e-marketplaces, such as the finance e-marketplace 704 and the logistics e-marketplace 706, mentioned above. In one embodiment, these ancillary e-marketplaces may be coupled to the goods e-marketplace 602 to provide an intermarket of goods and services, i.e., combining the goods and services of numerous industries into a single “one-stop” marketplace for a customer.

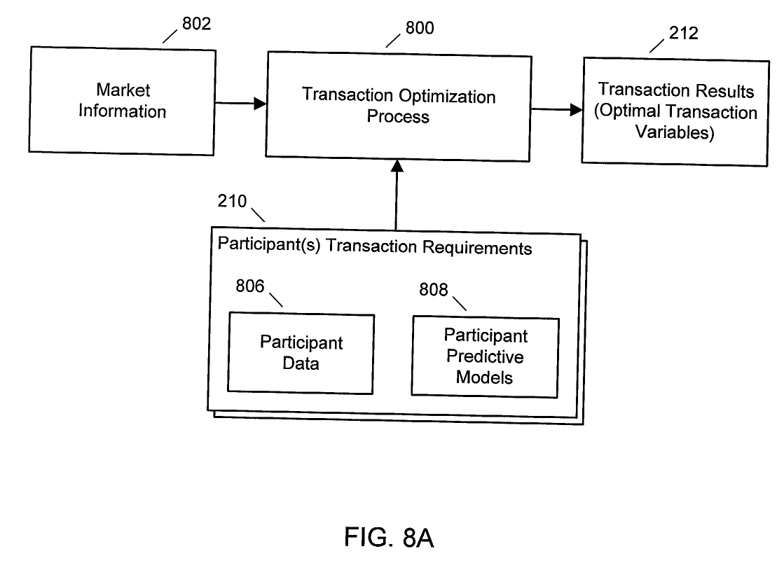

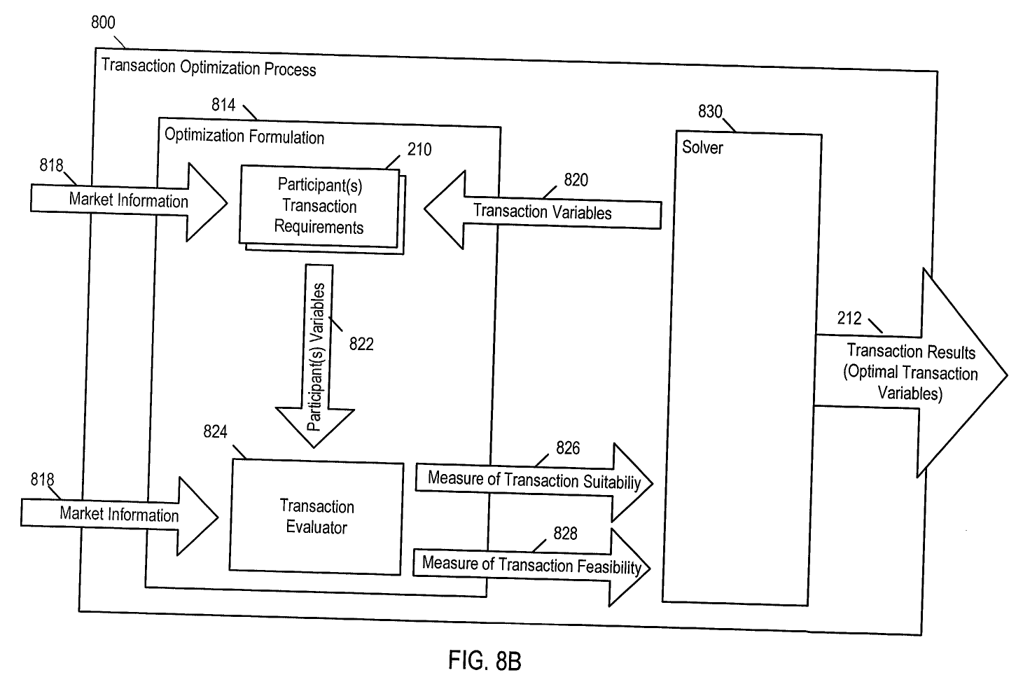

FIG. 8: Optimization Overview

FIG. 8a is a block diagram which illustrates an overview of optimization according to one embodiment. FIG. 8b is a dataflow diagram which illustrates an optimization process according to one embodiment. FIGS. 8a and 8b together illustrate an exemplary system for optimizing an e-marketplace system. While FIGS. 8a and 8b show an embodiment of an optimization system, various other embodiments may be suitable for implementing the invention.

As shown in FIG. 8a, a transaction optimization process 800 may accept the following elements as input: market information 802 and participant(s) transaction requirements 210. The optimization process 800 may produce as output transaction results 212 in the form of an optimized set of transaction variables. As used herein, “optimized” means that the selection of transaction values is based on a numerical search or selection process which maximizes a measure of suitability while satisfying a set of feasibility constraints. A further understanding of the optimization process 800 may be gained from the references “An Introduction to Management Science: Quantitative Approaches to Decision Making”, by David R. Anderson, Dennis J. Sweeney, and Thomas A. Williams, West Publishing Co. (1991); and “Fundamentals of Management Science” by Efraim Turban and Jack R. Meredith, Business Publications, Inc. (1988).

As used herein, the term “market information” may refer to any information generated, stored, or computed by the marketplace which provides context for the possible transactions. This information is not available to a participant without engaging in the e-market place. Furthermore, the market information is treated as a set of external variables in that those variables are not under the control of the transaction optimization process. For example, the marketplace might report the number of active participants, the recent historical demand for a particular product, or the current asking price for a product being sold. Additionally, market information may include information retrieved from other marketplaces.

As used herein, “transaction requirements” may include information that a participant provides to the optimization process to affect the outcome of the transaction optimization process. This information may include: (a) the participants objectives in accepting a transaction, (b) constraints describing what transaction parameters the participant will accept, (c) and internal participant data including inventory, production schedules, cost of goods sold, available funds, and/or required delivery times. Information may either be specified statically as participant data 806 or as participant predictive models 808 which allow information to be computed dynamically based on market information and transaction variables As used herein, an “objective” may include a goal or desired outcome of a transaction optimization process. Some example objectives are: obtain goods at a minimum price, sell goods in large lots, minimize delivery costs, and reduce inventory as rapidly as possible.

As used herein, a “constraint” may include a limitation on the outcome of an optimization process. Constraints may include “real-world” limits on the transaction variables and are often critical to the feasibility of any optimization solution. For example, a market-place seller may impose a minimum constraint on the volume of product that may be delivered in one transaction. A market-place buy may have a maximum price on a purchased product. Constraints may not be limited to transaction variables, but may be also be constraints of computed variables. For example, a seller may have a minimum limit on the margin of sales. This quantity is computed internally by the seller participant. Constraints may reflect financial or business constraints. They may also reflect physical production or delivery constraints.

As described above, the constraints and/or objectives provided by a participant may include parameter bounds or limits, functions, algorithms, and/or models which express the desired transaction requirements of the participant.

As used herein, “transaction variables” define the terms of a transaction. For example, the transaction variables might identify the selected participants, the volume of product exchanged, the purchase price, and the delivery terms. As used herein, “optimal transaction variables” define the final transaction, which is provided to two or more of the participants as transaction results 212. The optimization process 800 selects the optimal transaction variables in order to satisfy the constraints of the participants and best meet the objectives of the participants.

As shown in the dataflow of FIG. 8b, the transaction optimization process may comprise an optimization formulation 814 and a solver 830. The optimization formulation is a system which may take as input a proposed set of transaction variables 820 and market information 818. The optimization formulation computes both a measure of suitability for the proposed transaction 826 and one or more measures of feasibility for the proposed transaction 828. The solver determines a set of transaction variables that maximizes the transaction suitability over all participants while simultaneously ensuring that all of the transaction feasibility conditions are satisfied.

Before execution of the transaction optimization program, participants may each submit transaction requirements 210 to the marketplace. These requirements are incorporated into the optimization formulation 814. The participant transaction requirements 210 are used to compute or specify a set of participant variables 822 for each participant based on the market information 818, proposed transaction variables 820, and participant's unique properties. The participant variables are passed to a transaction evaluator 824 which determines the overall suitability 826 and feasibility 828 of the transaction variables 820 proposed by the solver. The solver uses these measure to refine the choice of transaction variables. After the optimization solver computes, selects, or creates the final set of transaction variables in response to the received data, the e-marketplace server, or a separate server, thereby producing transaction results 212 for the participants. The solver then provides the transaction results 212 to some or all of the participants. The transaction results 212 are provided to the client systems of the participants, where the results (transactions) are displayed, stored or automatically acted on. As discussed above, the transaction results 212 are preferably designed to achieve a desired commercial result, e.g., to complete a transaction in a desired way, such as by purchasing or selling a product.

Participant variables 822 are used to represent participant constraints and/or objectives to the transaction evaluator in a standard form. These variables are based on the participant's requirements. In one embodiment, the constraints and/or objectives are directly represented as participant data. For example, a buyer-participant may specify a product code, desired volume, and maximum unit price. In another example a seller may specify available product, minimum selling price, minimum order volume, and delivery time-window. In another embodiment, objective and constraint terms are computed as a function of transaction variables using predictive models. For example, a buyer may specify a maximum price computed based on a combination of the predicted market demand and seller's available volume. As another example, models may be used to translate a participant's strategic business objectives such as increase profit, increase market share, minimized inventory, etc., into standardized objective and constraint information based on current marketplace activity. In yet another embodiment, constraints and/or objectives are determined as a mixture of static data and dynamically computed values.

Predictive model(s) 808 may be used to compute participant variables such as constraints and/or objectives dynamically based on current marketplace information and proposed transaction variables. Models may estimate current or future values associated with the participant, other participants, or market conditions. Computations may represent different aspects of a participant's strategy. For example, a predictive model may represent the manufacturing conditions and behavior of a participant, a price-bidding strategy, the future state of a participant's product inventory, or the future behavior of other participants.

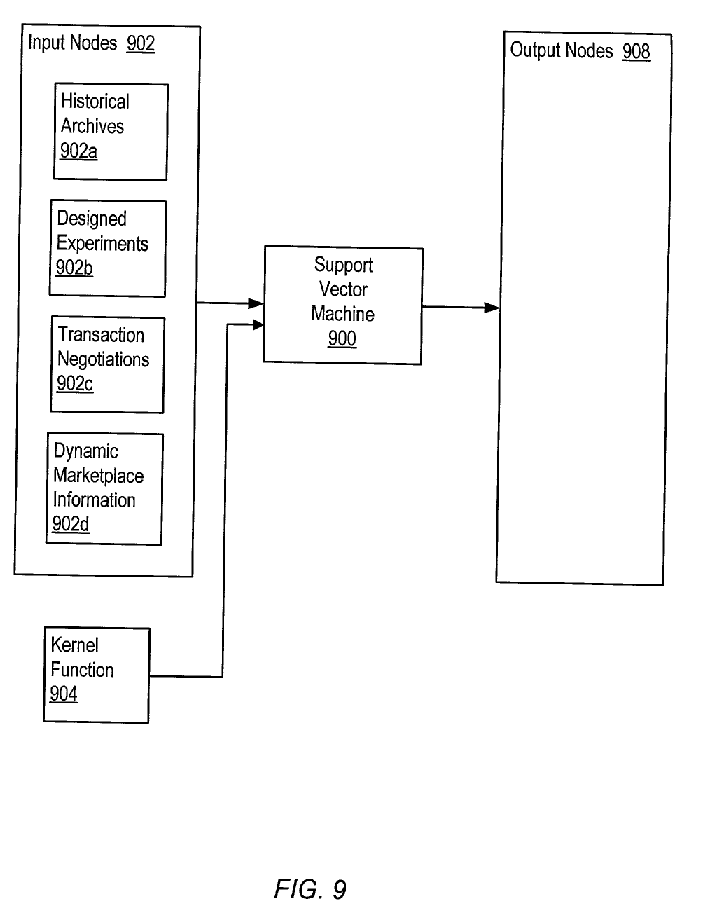

Predictive models 808 may take on any of a number of forms. In one embodiment, a model may be implemented as a non-linear model, such as a neural network or support vector machine (see FIG. 9). In the neural network implementation, typically, the neural network includes a layer of input nodes, interconnected to a layer of hidden nodes, which are in turn interconnected to a layer of output nodes, wherein each connection is associated with an adjustable weight or coefficient and wherein each node computes a non-linear function of values of source nodes. In the support vector machine implementation, typically, the support vector machine includes a layer of input nodes, interconnected to a layer of support vectors, which are in turn interconnected to a layer of output nodes, wherein each node computes a non-linear function of values of the support vectors. See FIG. 9 for more detail on a support vector machine implementation.

The support vectors are set in the training phase of the model. The model may be trained based on data extracted from historical archives, data gathered from designed experiments, or data gathered during the course of transaction negotiations. The model may be further trained based on dynamic marketplace information. In other embodiments, predictive models may be based on statistical regression methods, analytical formulas, physical first principles, or rule-based systems or decision-tree logic. In another embodiment, a model may be implemented as an aggregation of a plurality of model types.

Individual constraints and/or objectives 822 from two or more participants are passed to the transaction evaluator 824. The transaction evaluator combines the set of participant constraints to provide to the solver 830 one or more measures of transaction feasibility 828. The transaction evaluator also combines the individual objectives of the participants to provide to the solver 830 one or more measures of transaction suitability 826. The combination of objectives may be based on a number of different strategies. In one embodiment, the individual objectives levels may be combined by a weighted average. In a different embodiment, the individual objectives may be preserved and simultaneously optimized, such as in a Pareto optimal sense, as is well known in the art.

The solver 830 implements a constrained search strategy to determine the set of transaction variables that maximize the transaction suitability while satisfying the transaction feasibility constraints. Many strategies may be used and this invention allows solver strategies to be substituted as necessary to satisfy the requirements of a particular marketplace type. Examples of search strategies may include gradient-based solvers such as linear programming, non-linear programming, mixed-integer linear and/or non-linear programming. Search strategies may also include non-gradient methods such as genetic algorithms and evolutionary programming techniques. Solvers may be implemented as custom optimization processes or off-the-shelf applications or libraries.

For more information on one embodiment of an optimization process for an e-marketplace see U.S. patent application Ser. No. 09/493,951, titled “System And Method For Optimization Including Cross-Record Constraints”, filed on Jan. 28, 2000 and U.S. patent application Ser. No. 09/493,404, titled “System And Method For Generating Inducements During E-Commerce Transactions Using An Optimization Process”, filed on Jan. 28, 2000, which are both hereby incorporated by reference.

As mentioned above, the e-Marketplace system described herein may include one or more predictive models used to represent various aspects of the system, such as the participants, the related market, or any other attribute of the system. In one embodiment, one or more of the predictive models may be implemented as a neural network. In another embodiment, one or more of the predictive models may be implemented as a support vector machine. Both of these model types share the property that to be useful they may be trained with data, and internal weights or coefficients may be set to reconcile input training data with expected or desired output data.

FIG. 9: Support Vector Machine Implementation

In order to fully appreciate the various aspects and benefits produced by various embodiments of the present invention, an understanding of support vector machine technology is useful. For this reason, the following section discusses support vector machine technology as applicable to the support vector machine 900 of the system and method of various embodiments of the present invention.

Introduction

Historically, classifiers have been determined by choosing a structure, and then selecting a parameter estimation algorithm used to optimize some cost function. The structure chosen may fix the best achievable generalization error, while the parameter estimation algorithm may optimize the cost function with respect to the empirical risk.

There are a number of problems with this approach, however. These problems may include:

1. The model structure needs to be selected in some manner. If this is not done correctly, then even with zero empirical risk, it is still possible to have a large generalization error.

2. If it is desired to avoid the problem of over-fitting, as indicated by the above problem, by choosing a smaller model size or order, then it may be difficult to fit the training data (and hence minimize the empirical risk).

3. Determining a suitable learning algorithm for minimizing the empirical risk may still be quite difficult. It may be very hard or impossible to guarantee that the correct set of parameters is chosen.

The support vector method is a recently developed technique which is designed for efficient multidimensional function approximation. The basic idea of support vector machines (SVMs) is to determine a classifier or regression machine which minimizes the empirical risk (i.e., the training set error) and the confidence interval (which corresponds to the generalization or test set error), that is, to fix the empirical risk associated with an architecture and then to use a method to minimize the generalization error. One advantage of SVMs as adaptive models for binary classification and regression is that they provide a classifier with minimal VC (Vapnik-Chervonenkis) dimension which implies low expected probability of generalization errors. SVMs may be used to classify linearly separable data and nonlinearly separable data. SVMs may also be used as nonlinear classifiers and regression machines by mapping the input space to a high dimensional feature space. In this high dimensional feature space, linear classification may be performed.

In the last few years, a significant amount of research has been performed in SVMs, including the areas of learning algorithms and training methods, methods for determining the data to use in support vector methods, and decision rules, as well as applications of support vector machines to speaker identification, and time series prediction applications of support vector machines.

Support vector machines have been shown to have a relationship with other recent nonlinear classification and modeling techniques such as: radial basis function networks, sparse approximation, PCA (principle components analysis), and regularization. Support vector machines have also been used to choose radial basis function centers.

A key to understanding SVMs is to see how they introduce optimal hyperplanes to separate classes of data in the classifiers. The main concepts of SVMs are reviewed in the next section.

How Support Vector Machines Work

The following describes support vector machines in the context of classification, but the general ideas presented may also apply to regression, or curve and surface fitting.

1. Optimal Hyperplanes

Consider an m-dimensional input vector x=[x₁, . . . ,xₘ]^{T}εX⊂R^{m} and a one-dimensional output yε{−1,1}. Let there exist n training vectors (xᵢ,yᵢ) i=1, . . . ,n. Hence we may write X=[x₁x₂ . . . xₙ] or

$$X = [ \begin{matrix}{x}_{11} & … & {x}_{1 n} \\ ⋮ & ⋰ & ⋮ \\ {x}_{m} & … & {x}_{m} \\ 1 & & n\end{matrix} ] \qquad ( 1 )$$

A hyperplane capable of performing a linear separation of the training data is described by

w^{T}x+b=0 (2)

where w=[w₁w₂ . . . wₘ]^{T}, wεW⊂R^{m}.

The concept of an optimal hyperplane was proposed by Vladimir Vapnik. For the case where the training data is linearly separable, an optimal hyperplane separates the data without error and the distance between the hyperplane and the closest training points is maximal.

2. Canonical Hyperplanes

A canonical hyperplane is a hyperplane (in this case we consider the optimal hyperplane) in which the parameters are normalized in a particular manner.

Consider (2) which defines the general hyperplane. It is evident that there is some redundancy in this equation as far as separating sets of points. Suppose we have the following classes

yᵢ[w^{T}xᵢ+b]≧1 i=1, . . . ,n (3)

where yε[−1,1].

One way in which we may constrain the hyperplane is to observe that on either side of the hyperplane, we may have w^{T}x+b>0 or w^{T}x+b<0. Thus, if we place the hyperplane midway between the two closest points to the hyperplane, then we may scale w,b such that

min |w^{T}xᵢ+b|=0 (4)

i−1. . . n

Now, the distance d from a point xᵢ to the hyperplane denoted by (w,b) is given by

$$d ( w , b ; {x}_{i} ) = \frac{\vert {w}^{T} {x}_{i} + b \vert}{‖ w ‖} \qquad ( 5 )$$

where ∥w∥=w^{T}w. By considering two points on opposite sides of the hyperplane, the canonical hyperplane is found by maximizing the margin

$$\begin{matrix}p ( w , b ) = {min}_{i ; {y}_{i} = 1} d ( w , b ; {x}_{i} ) + {min}_{j ; yj = 1} d ( w , b ; {x}_{j} ) \\ = \frac{2}{‖ w ‖}\end{matrix} \qquad ( 6 )$$

This implies that the minimum distance between two classes i and j is at least [2/(|w|)].

Hence an optimization function which we seek to minimize to obtain canonical hyperplanes, is

$$J ( w ) = \frac{1}{2} {‖ w ‖}^{2} \qquad ( 7 )$$

Normally, to find the parameters, we would minimize the training error and there are no constraints on w,b. However, in this case, we seek to satisfy the inequality in (3). Thus, we need to solve the constrained optimization problem in which we seek a set of weights which separates the classes in the usually desired manner and also minimizing J(w), so that the margin between the classes is also maximized. Thus, we obtain a classifier with optimally separating hyperplanes.

An SVM Learning Rule

For any given data set, one possible method to determine w₀,b₀ such that (8) is minimized would be to use a constrained form of gradient descent. In this case, a gradient descent algorithm is used to minimize the cost function J(w), while constraining the changes in the parameters according to (3). A better approach to this problem however, is to use Lagrange multipliers which is well suited to the nonlinear constraints of (3). Thus, we introduce the Lagrangian equation:

$$L ( w , b , α ) = \frac{1}{2} {‖ w ‖}^{2} - {\sum }_{i = 1}^{n} {α}_{i} ( {y}_{i} [ {w}^{T} {x}_{i} + b ] - 1 ) \qquad ( 8 )$$

where αᵢ are the Lagrange multipliers and α₁>0.

The solution is found by maximizing L with respect to αᵢ and minimizing it with respect to the primal variables w and b. This problem may be transformed from the primal case into its dual and hence we need to solve

max min L(w,b,α) (9)

α w,b

At the solution point, we have the following conditions

$$\frac{\partial L ( {w}_{0} , {b}_{0} , {α}_{0} )}{\partial w} = 0 \\ \frac{\partial L ( {w}_{0} , {b}_{0} , {α}_{0} )}{\partial b} = 0 \qquad ( 10 )$$

where solution variables w₀,b₀,α₀ are found. Performing the differentiations, we obtain respectively,

$${\sum }_{i = 1}^{n} {α}_{0 i} {y}_{i} = 0 \\ {w}_{0} = {\sum }_{i = 1}^{n} {α}_{0 i} {x}_{i} {y}_{i} \qquad ( 11 )$$

and in each case α₀ᵢ>0, i=1, . . . ,n.

These are properties of the optimal hyperplane specified by (w₀,b₀). From (14) we note that given the Lagrange multipliers, the desired weight vector solution may be found directly in terms of the training vectors.

To determine the specific coefficients of the optimal hyperplane specified by (w,b₀) we proceed as follows. Substitute (13) and (14) into (9) to obtain

$${L}_{D} ( w , b , α ) = {\sum }_{i = 1}^{n} {α}_{i} - \frac{1}{2} {\sum }_{i = 1}^{n} {\sum }_{j = 1}^{n} {α}_{i} {α}_{j} {y}_{i} {y}_{j} ( {x}_{i}^{T} {x}_{j} ) \qquad ( 12 )$$

It is necessary to maximize the dual form of the Lagrangian equation in (15) to obtain the required Lagrange multipliers. Before doing so however, consider (3) once again. We observe that for this inequality, there will only be some training vectors for which the equality holds true. That is, only for some (xᵢ,yᵢ) will the following equation hold:

yᵢ[w^{T}xᵢ+b]=1, . . . ,n (13)

The training vectors for which this is the case, are called support vectors.

Since we have the Karush-Kuhn-Tucker (KKT) conditions that α₀ᵢ>0, i=1, . . . ,n and that given by (3), from the resulting Lagrangian equation in (9), we may write a further KKT condition

α₀ᵢ(yᵢ[w₀^{T}xᵢ+b₀]−1)=0 i=1, . . . ,n (14)

This means, that since the Lagrange multipliers α₀ᵢ are nonzero with only the support vectors as defined in (16), the expansion of w₀ in (14) is with regard to the support vectors only.

Hence we have

$${w}_{0} = {\sum }_{i ⋐ S} {α}_{0 i} {x}_{i} {y}_{i} \qquad ( 15 )$$

where S is the set of all support vectors in the training set. To obtain the Lagrange multipliers α₀ᵢ, we need to maximize (15) only over the support vectors, subject to the constraints α₀ᵢ>0, i=1, . . . ,n and that given in (13). This is a quadratic programming problem and may be readily solved. Having obtained the Lagrange multipliers, the weights w₀ may be found from (18).

Classification of Linearly Separable Data

A support vector machine which performs the task of classifying linearly separable data is defined as

f(x)=sgn{w^{T}x+b} (16)

where w,b are found from the training set. Hence may be written as

$$f ( x ) = sgn \{ {\sum }_{i ⋐ S} {α}_{0 i} {y}_{i} ( {x}_{i}^{T} x ) + {b}_{0} \} \qquad ( 17 )$$

where α₀ᵢ are determined from the solution of the quadratic programming problem in (15) and b₀ is found as

$${b}_{0} = \frac{1}{2} ( {w}_{0}^{T} {x}_{i}^{+} + {w}_{0}^{T} {x}_{i}^{-} ) \qquad ( 18 )$$

where xᵢ⁺ and xᵢ⁻0 are any input training vector examples from the positive and negative classes respectively. For greater numerical accuracy, we may also use

$${b}_{0} = \frac{1}{2 n} {\sum }_{i = 1}^{n} ( {w}_{0}^{T} {x}_{i}^{+} + {w}_{0}^{T} {x}_{i}^{-} ) \qquad ( 19 )$$

Classification of Nonlinearly Separable Data

For the case where the data is nonlinearly separable, the above approach can be extended to find a hyperplane which minimizes the number of errors on the training set. This approach is also referred to as soft margin hyperplanes. In this case, the aim is to

yᵢ[w^{T}xᵢ+b]≧1−ξᵢ i=1, . . . ,n (20)

where ξᵢ>0, i=1, . . . ,n. In this case, we seek to minimize to optimize

$$J ( w , ξ ) = \frac{1}{2} {‖ w ‖}^{2} + C {\sum }_{i = 1}^{n} {ξ}_{i} \qquad ( 21 )$$

Nonlinear Support Vector Machines

For some problems, improved classification results may be obtained using a nonlinear classifier. Consider (20) which is a linear classifier. A nonlinear classifier may be obtained using support vector machines as follows.

The classifier is obtained by the inner product xᵢ^{T}x where i⊂S, the set of support vectors. However, it is not necessary to use the explicit input data to form the classifier. Instead, all that is needed is to use the inner products between the support vectors and the vectors of the feature space.

That is, by defining a kernel

K(xᵢ,x)=xᵢ^{T}x (22)

a nonlinear classifier can be obtained as

$$f ( x ) = sgn \{ {\sum }_{i ⋐ S} {α}_{0 i} {y}_{i} K ( {x}_{i} , x ) + {b}_{0} \} \qquad ( 23 )$$

Kernel Functions

A kernel function may operate as a basis function for the support vector machine. In other words, the kernel function may be used to define a space within which the desired classification or prediction may be greatly simplified. Based on Mercer's theorem, as is well known in the art, it is possible to introduce a variety of kernel functions, including:

1. Polynomial

The p^{th} order polynomial kernel function is given by

K(xᵢ,x)= (24)

2. Radial Basis Function

K(xᵢ,x)=e (25)

where γ>0.

3. Multilayer Networks

A multilayer network may be employed as a kernel function as follows. We have

K(xᵢ,x)=σ(θ(xᵢ^{T}x)+φ) (26)

where σ is a sigmoid function.

Note that the use of a nonlinear kernel permits a linear decision function to be used in a high dimensional feature space. We find the parameters following the same procedure as before. The Lagrange multipliers may be found by maximizing the functional

$${L}_{D} ( w , b , α ) = {\sum }_{i = 1}^{n} {α}_{i} - \frac{1}{2} {\sum }_{i = 1}^{n} {\sum }_{j = 1}^{n} {α}_{i} {α}_{j} {y}_{i} {y}_{j} K ( {x}_{i} , x ) \qquad ( 27 )$$

When support vector methods are applied to regression or curve-fitting, a high-dimensional “tube” with a radius of acceptable error is constructed which minimizes the error of the data set while also maximizing the flatness of the associated curve or function. In other words, the tube is an envelope around the fit curve, defined by a collection of data points nearest the curve or surface, i.e., the support vectors.

Thus, support vector machines offer an extremely powerful method of obtaining models for classification and regression. They provide a mechanism for choosing the model structure in a natural manner which gives low generalization error and empirical risk.

Construction of Support Vector Machines

As shown in FIG. 9, one embodiment of a support vector machine 900 may be built by specifying a kernel function 904, a number of inputs or input nodes 902 (e.g., historical archives 902a, designed experiments 902b, transaction negotiations 902c, dynamic marketplace information 902d, among other inputs, not shown), and a number of outputs or output nodes 908. The support vector machine 900 may include a layer of support vectors (not shown). Of course, as is well known in the art, regardless of the particular configuration of the support vector machine, some type of training process may be used to capture the behaviors and/or attributes of the system or process to be modeled. Typically, more complex support vector machines require more configuration information than less complex support vector machines, and therefore more storage.

Various embodiments of the present invention may contemplate other types of support vector machine configurations for use with support vector machine 900. All that is required for support vector machine 900 is that the support vector machine be able to be trained and retrained so as to provide the needed predicted values utilized in the transaction optimization process 800.

Support Vector Machine Training

The coefficients used in support vector machine 900 may be adjustable constants which determine the values of the predicted output data for given input data for any given support vector machine configuration. Support vector machines may be superior to conventional statistical models because support vector machines may adjust these coefficients automatically. Thus, support vector machines may be capable of building the structure of the relationship (or model) between the input data 902 and the output data 908 by adjusting the coefficients. While a conventional statistical model requires the developer to define the equation(s) in which adjustable constant(s) are used, the support vector machine 900 builds the equivalent of the equation(s) automatically.

The support vector machine 900 may be trained by presenting it with one or more training set(s). The one or more training set(s) are the actual history of known input data values and the associated correct output data values.

To train the support vector machine, the newly configured support vector machine is usually initialized by assigning random values to all of its coefficients. During training, the support vector machine 900 may use its input data 902 to produce predicted output data 908.

These predicted output data values 908 may be used in combination with training input data to produce error data. These error data values may then be used to adjust the coefficients of the support vector machine.

It may thus be seen that the error between the output data 908 and the training input data may be used to adjust the coefficients so that the error is reduced.

Advantages of Support Vector Machines

Support vector machines may be superior to computer statistical models because support vector machines do not require the developer of the support vector machine model to create the equations which relate the known input data and training values to the desired predicted values (i.e., output data). In other words, support vector machine 900 may learn the relationships automatically in the training phase of the model.

However, it should be noted that support vector machine 900 requires the collection of training input data with its associated input data, also called a training set. The training set may need to be collected and properly formatted. The conventional approach for doing this is to create a file on a computer on which the support vector machine is executed.

In one embodiment of the present invention, in contrast, creation of the training set is done automatically using an historical archive or database 902a. This automatic step may eliminate errors and may save time, as compared to the conventional approach. Another benefit may be significant improvement in the effectiveness of the training function, since automatic creation of the training set(s) may be performed much more frequently.

Referring to FIG. 8, one embodiment of the present invention may include a predictive model 808 in the form of a computer support vector machine which produces transaction results 212 using a trained support vector machine supplied with input data at a specified interval.

Various embodiments of the present invention may be configured by a developer using a support vector machine configuration in the training phase of the model. Various parameters of the support vector machine may be specified by the developer by using natural language without knowledge of specialized computer syntax and training. For example, parameters specified by the user may include the type of kernel function, the number of inputs, the number of outputs, as well as algorithm parameters such as cost of constraint violations, and convergence tolerance (epsilon). Other possible parameters specified by the user may depend on which kernel is chosen (e.g., for gaussian kernels, one may specify the standard deviation, for polynomial kernels, one may specify the order of the polynomial). In one embodiment, there may be default values (estimates) for these parameters which may be overridden by user input.

In this way, various embodiments of the present invention may allow an e-commerce and/or e-marketplace expert to configure the system without the use of a support vector machine expert.

The support vector machine may be automatically trained on-line using input data 902 and associated training input data having timestamps (not shown). The input data 902 and associated training input data may be stored in historical database 902a, which may supply this data (i.e., input data 902 and associated training input data) to the support vector machine 900 for training at specified intervals.

Error data may be used for automatically retraining the support vector machine. The retraining of the support vector machine may result in the output data 908 approaching the training input data as much as possible over the operation of the process. In this way, various embodiments of the present invention may effectively adapt to changes in the process, which may occur in a commercial application.

While the present invention has been described with reference to particular embodiments, it will be understood that the embodiments are illustrated and that the invention scope is not so limited. Any variations, modifications, additions and improvements to the embodiments described are possible. These variations, modifications, additions and improvements may fall within the scope of the invention as detailed within the following claims.

What is claimed is:

1. A system for optimizing a transaction among a plurality of participants, the system comprising:
a server computer system which includes a processor and a memory medium, wherein the memory medium of the server computer system stores a transaction optimization program for optimizing the transaction among the plurality of participants in the transaction; and
a plurality of participant computer systems operable to be coupled to the server computer system, wherein each of the plurality of participant computer systems is operated by one of the plurality of participants, wherein each of the plurality of participant computer systems is operable to provide transaction information to the server computer system, wherein, for each of the plurality of participants, the transaction information includes one or more of constraints and objectives related to the transaction;
wherein the server computer system is operable to execute the transaction optimization program using the transaction information from each of the plurality of participant computer systems to produce transaction results for each of the plurality of participants;
wherein the transaction optimization program uses a model to predict transaction results for each of the participants; and
wherein the model is a support vector machine.

2. The system of claim 1, wherein the system for optimizing a transaction among a plurality of participants functions as an e-marketplace, wherein the e-marketplace comprises a forum to facilitate transactions between the participants, wherein the e-marketplace comprises an e-commerce site hosted on an e-commerce server computer system, and wherein the model comprises a model of the e-marketplace.

3. The system of claim 1, wherein the support vector machine further comprises:
a layer of input nodes;
a layer of support vectors interconnected to the layer of input nodes;
a layer of output nodes interconnected to the layer of support vectors.

4. The system of claim 3, wherein each output node computes a non-linear function of values of the support vectors.

5. The system of claim 1,
wherein the transaction optimization program is executable to receive the transaction information from each of the plurality of participant computer systems; and
wherein the transaction optimization program includes or is coupled to an optimizer which operates to optimize the transaction according to one or more of the constraints and objectives comprised in the transaction information from each of the plurality of participant computer systems.

6. The system of claim 1, wherein the transaction information of each participant is stored on the participant computer system.

7. The system of claim 1, wherein the transaction information of each participant is stored on the server computer system.

8. The system of claim 1,
wherein the server computer system is operable to provide the transaction results to each of the plurality of participant computer systems; and
wherein each of the plurality of participant computer systems is operable to receive and display the transaction results.

9. The system of claim 1,
wherein the memory medium of the server computer system also stores an interface program, wherein the interface program is executable to present a graphical user interface to each of the plurality of participant computer systems; and
wherein each of the plurality of participant computer systems is operable to input the transaction information using the graphical user interface provided by the interface program.

10. The system of claim 1,
wherein at least one participant is a buyer and a plurality of participants are sellers, wherein the transaction comprises a purchase by the at least one buyer of a product from one of the plurality of sellers; and
wherein the transaction results comprise selection of at least one seller from the plurality of sellers to sell the product to the at least one buyer.

11. The system of claim 1,
wherein at least one participant is a seller and a plurality of participants are buyers, wherein the transaction comprises a purchase by one or more of the plurality of buyers of a product from the at least one seller; and
wherein the transaction results comprise selection of at least one buyer from the plurality of buyers to buy the product from the at least one seller.

12. The system of claim 1,
wherein the transaction optimization program is executable to request new transaction information from each of the plurality of participant computer systems in response to determining that the transaction optimization program is not able to produce transaction results based on the current transaction information.

13. The system of claim 1,
wherein the server computer system is operable to be coupled to a network; and
wherein each of the plurality of participant computer systems is operable to be coupled to the network.

14. The system of claim 1,
wherein the system functions as an e-marketplace, wherein the e-marketplace comprises a forum to facilitate transactions between the participants, and wherein the e-marketplace comprises an e-commerce site hosted on an e-commerce server computer system.

15. The system of claim 14,
wherein the transactions comprise buying and selling of chemical products and services.

16. The system of claim 14,
wherein the transactions comprise buying and selling of paper products and services.

17. The system of claim 14,
wherein the transactions comprise buying and selling of insurance products and services.

18. The system of claim 14,
wherein the transactions comprise buying and selling of financial products and services.

19. The system of claim 14,
wherein the transactions comprise buying and selling of metal products and services.

20. The system of claim 1,
wherein each of the plurality of participant computer systems is operable to adjust its transaction information and re-submit the adjusted transaction information to the server after receiving the transaction results;
wherein the transaction optimization program is executable to receive the adjusted transaction information from each of the plurality of participant computer systems; and
wherein the transaction optimization program operates to optimize the transaction according to one or more of the constraints and objectives comprised in the adjusted transaction information from each of the plurality of participant computer systems.

21. A system for optimizing a transaction among a plurality of participants, the system comprising:
a processor;
an input for coupling to a network, wherein the input is operable to receive transaction information from the plurality of participants, wherein, for each of the plurality of participants, the transaction information includes one or more of constraints and objectives related to the transaction;
a memory medium coupled to the processor, wherein the memory medium stores a transaction optimization program for optimizing transactions among the plurality of participants in the transaction, wherein the memory medium is also operable to receive and store the transaction information from the plurality of participants;
wherein the processor is operable to execute the transaction optimization program using the transaction information from each of the plurality of participants to produce transaction results for each of the plurality of participants;
wherein the transaction optimization program uses a model to predict transaction results for each of the participants; and
wherein the model is a support vector machine.

22. The system of claim 21, wherein the system functions as an e-marketplace, wherein the e-marketplace comprises a forum to facilitate transactions between the participants, wherein the e-marketplace comprises an e-commerce site hosted on an e-commerce server computer system, and wherein the model comprises a model of the e-marketplace.

23. The system of claim 21, wherein the support vector machine further comprises:
a layer of input nodes;
a layer of support vectors interconnected to the layer of input nodes;
a layer of output nodes interconnected to the layer of support vectors.

24. The system of claim 23, wherein each output node computes a non-linear function of values of the support vectors.

25. The system of claim 21,
wherein the transaction optimization program includes an optimizer which operates to optimize the transaction according to one or more of the constraints and objectives comprised in the transaction information from each of the plurality of participants.

26. The system of claim 21, further comprising an output for coupling to the network, wherein the output is operable to provide the transaction results to each of the plurality of participants.

27. The system of claim 21,
wherein the memory medium also stores an interface program, wherein the interface program is executable to present a graphical user interface to each of the plurality of participants; and
wherein the graphical user interface provided by the interface program is operable to accept the transaction information from each of the plurality of participants.

28. The system of claim 21,
wherein at least one participant is a buyer and a plurality of participants are sellers, wherein the transaction comprises a purchase by the at least one buyer of a product from one of the plurality of sellers; and
wherein the transaction results comprise selection of at least one seller from the plurality of sellers to sell the product to the at least one buyer.

29. The system of claim 21,
wherein at least one participant is a seller and a plurality of participants are buyers, wherein the transaction comprises a purchase by one or more of the plurality of buyers of a product from the at least one seller; and
wherein the transaction results comprise selection of at least one buyer from the plurality of buyers to buy the product from the at least one seller.

30. The system of claim 21,
wherein the transaction optimization program is executable to request new transaction information from each of the plurality of participants in response to determining that the transaction optimization program is not able to produce transaction results based on the current transaction information.

31. The system of claim 21,
wherein the transactions comprise buying and selling of chemical products and services.

32. The system of claim 21,
wherein the transactions comprise buying and selling of paper products and services.

33. The system of claim 21,
wherein the transactions comprise buying and selling of insurance products and services.

34. The system of claim 21,
wherein the transactions comprise buying and selling of financial products and services.

35. The system of claim 21,
wherein the transactions comprise buying and selling of metal products and services.

36. The system of claim 21,
wherein the input is further operable to receive adjusted transaction information from each of the plurality of participants after the transaction results have been provided to the each of the plurality of participants, wherein the transaction optimization program operates to optimize the transaction according to one or more of the constraints and objectives comprised in the adjusted transaction information from each of the plurality of participants.

37. The system of claim 21, wherein the transaction information of each participant are stored on a participant computer system, wherein for each participant, the participant computer system is operated by or on behalf of the participant.

38. The system of claim 21, wherein the transaction information of each participant are stored on the server computer system.

39. A method for optimizing transactions among a plurality of participants, the method comprising:
receiving transaction information from each of the plurality of participants in the transaction, wherein, for each of the plurality of participants, the transaction information includes one or more of constraints and objectives related to the transaction;
executing a transaction optimization program using the transaction information from each of the plurality of participants to produce transaction results for each of the plurality of participants; and
providing the transaction results to the plurality of participants;
wherein the executing the transaction optimization program includes executing an optimizer which operates to optimize the transaction according to one or more of the constraints and objectives comprised in the transaction information from each of the plurality of participants;
wherein the executing the transaction optimization program includes using a model to predict transaction results for each of the participants; and
wherein the model is a support vector machine.

40. The method of claim 39, wherein the method implements an e-marketplace, wherein the e-marketplace comprises a forum to facilitate transactions between the participants, wherein the e-marketplace comprises an e-commerce site hosted on an e-commerce server computer system, and wherein the model comprises a model of the e-marketplace.

41. The method of claim 39, wherein the support vector machine further comprises:
a layer of input nodes;
a layer of support vectors interconnected to the layer of input nodes;
a layer of output nodes interconnected to the layer of support vectors.

42. The method of claim 41, wherein each output node computes a non-linear function of values of the support vectors.

43. The method of claim 39, further comprising executing an interface program to present a graphical user interface to each of the plurality of participants;
wherein the graphical user interface provided by the interface program is operable to accept the transaction information from each of the plurality of participants.

44. The method of claim 39,
wherein at least one participant is a buyer and a plurality of participants are sellers, wherein the transaction comprises a purchase by the at least one buyer of a product from one of the plurality of sellers; and
wherein the transaction results comprise selection of at least one seller from the plurality of sellers to sell the product to the at least one buyer.

45. The method of claim 39,
wherein at least one participant is a seller and a plurality of participants are buyers, wherein the transaction comprises a purchase by one or more of the plurality of buyers of a product from the at least one seller; and
wherein the transaction results comprise selection of at least one buyer from the plurality of buyers to buy the product from the at least one seller.

46. The method of claim 39,
wherein executing the transaction optimization program further comprises requesting new transaction information from each of the plurality of participants in response to determining that the transaction optimization program is not able to produce transaction results based on the received transaction information.

47. The method of claim 39,
wherein the method implements an e-marketplace, wherein the e-marketplace comprises a forum to facilitate transactions between the participants, and wherein the e-marketplace comprises an e-commerce site hosted on an e-commerce server computer system.

48. The system of claim 47,
wherein the transactions comprise buying and selling of chemical products and services.

49. The system of claim 47,
wherein the transactions comprise buying and selling of paper products and services.

50. The system of claim 47,
wherein the transactions comprise buying and selling of insurance products and services.

51. The system of claim 47,
wherein the transactions comprise buying and selling of financial products and services.

52. The method of claim 39, further comprising:
receiving adjusted transaction information from each of the plurality of participants after the providing the transaction results to the plurality of participants, wherein, for each of the plurality of participants, the adjusted transaction information includes one or more of adjusted constraints and adjusted objectives related to the transaction;
executing the transaction optimization program using the adjusted transaction information from each of the plurality of participants to produce adjusted transaction results for each of the plurality of participants; and
providing the adjusted transaction results to the plurality of participants.

53. The method of claim 39, wherein the transaction information of each participant are stored on a participant computer system, wherein for each participant, the participant computer system is operated by or on behalf of the participant.

54. The method of claim 39, further comprising storing the transaction information of each participant on the server computer system.
